(19) United States
(12) Patent Application Publication
(10) Pub. No.: US 2015/0042550 A1
(43) Pub. Date: Feb. 12, 2015

(54) DISPLAY PANEL HAVING REPAIRING STRUCTURE

(71) Applicant: Century Technology (Shenzhen) Corporation Limited, Shenzhen (CN)

(72) Inventors: MING-TSUNG WANG, New Taipei (TW); KUO-CHIEH CHI, New Taipei (TW); WEN-LIN MEI, Shenzhen (CN); HUI WANG, Shenzhen (CN)

(21) Appl. No.: 14/453,854

(22) Filed: Aug. 7, 2014

(30) Foreign Application Priority Data
Aug. 8, 2013 (CN) 2013103415986

(51) Int. Cl. G02F 1/13; G09G 3/36

(52) U.S. Cl. CPC G02F 1/1309; G09G 3/3611; G02F 1/136259
USPC 345/98

(57) ABSTRACT

A display panel having a repairing structure has a display region and a periphery circuit region surrounding the display region. At least one scan line, at least one first connection line and a gate driver are positioned on the periphery circuit region. The gate driver is configured to output a gate signal to the scan line via the connection line. The repairing structure comprises a first repairing wire and a driving chip positioned on the periphery circuit region. The driving chip is located at one end of the first repairing wire. The driving chip is configured to output a repairing gate signal to the connection line via the first repairing wire when the gate signal provide to the scan line from the gate driver is abnormal.

### CROSS-REFERENCE TO RELATED APPLICATIONS

This application claims all benefits accruing under 35 U.S.C. §119 from Chinese Patent Application No. 201310341598.6, filed on Aug. 8, 2013 in the Chinese Intellectual Property Office, the content of which is hereby incorporated by reference.

### FIELD

The present disclosure relates to a display panel having a repairing structure.

### BACKGROUND

A display panel include a display region included a plurality of pixel units and a periphery circuit region included a source driver and a gate driver. The source driver and the gate driver are configured to drive the pixel units to display images. The source driver is configured to provide a plurality of display data to the pixel units. The gate driver is configured to provide a plurality of gate signals to the pixel units capable of controlling the pixel unit to write in the display data. However, when one of the gate signals is abnormal, the display data is could not normally write into the pixel unit, and the display panel could not normally display images.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a diagrammatic view of a repairing structure of liquid crystal display panel according to one embodiment.

FIG. 2 is a diagrammatic view of the repairing structure of FIG. 1.

FIG. 3 is a cross-sectional view of the repairing structure taken along line III-III of FIG. 2.

FIG. 4 is a cross-sectional view of the repairing structure taken along line IV-IV of FIG. 2.

### DETAILED DESCRIPTION

Reference will be made to the drawings to describe various embodiments.

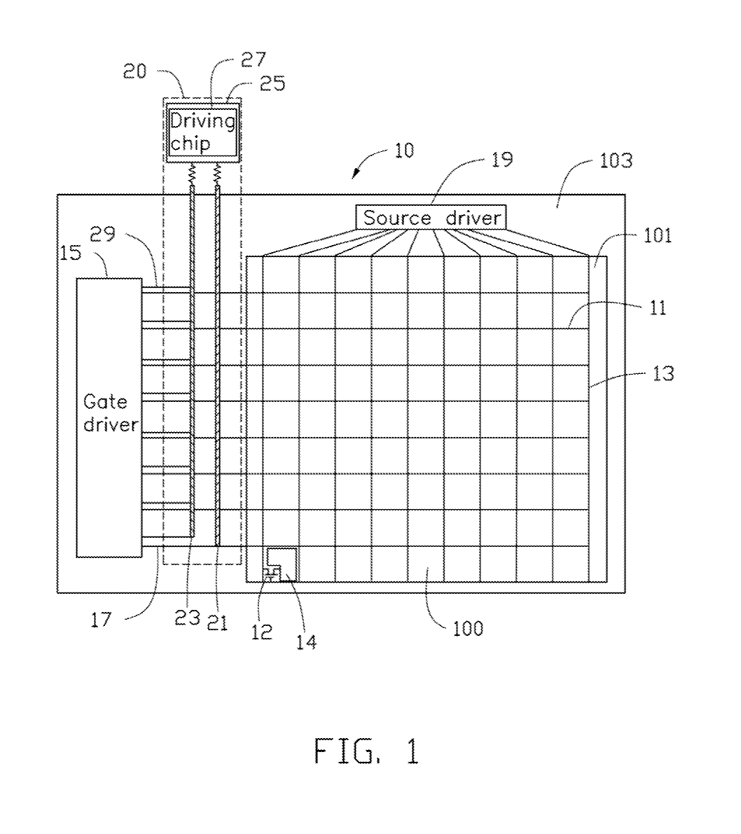

FIG. 1 shows a diagrammatic view of display panel 10 according to one embodiment of the present disclosure. The panel 10 includes a display region 101 and a periphery circuit region 103 surrounding the display region 101. The display region 101 is configured to display images. A plurality of scan lines 11 and a plurality of data lines 13 are positioned on the display region 101. The scan lines 11 and the data lines 13 are intersected and insulated from each other. The scan lines 11 and the data lines 13 define a plurality of pixel units 100 arranged in a matrix on the display region 103. At least one thin film transistor (TFT) 12 and at least one pixel electrode 14 are positioned on each of the pixel 100. The display panel 10 can be a liquid crystal display panel.

The periphery circuit region 103 is a non-display region. A gate driver 15, a plurality of first connection lines 17, a source driver 19 and a repairing structure 20 are positioned on the periphery circuit region 103. The gate driver 15 is electrically connected to the scan lines 11 via the first connection lines 17. Each of the first connection lines 17 is electrically connected to one of the scan lines 11. The gate driver 15 is configured to provide a plurality of gate signals to TFTs 12 through the first connection lines 17, and the gate signal is configured to sequentially select and turn on the TFTs 12. The source driver 19 is electrically connected to the TFTs 12 via the date lines 13. The source driver 19 is configured to provide a plurality of display data to the pixel electrodes 14 via the TFTs 12.

The repairing structure 20 includes a first repairing wire 21, a second repairing wire 23, a driving chip 25, a flexible printed circuit board (FPC) 27 and a plurality of second connection lines 29. The first repairing wire 21 and the second repairing wire 23 are positioned on the periphery circuit region 103 and are parallel to the data lines 13. The first repairing wire 21 and the second repairing wire 23 are intersected with the first connection lines 17 and insulated from each other. The FPC 27 is located at one end of the first repairing wire 21 and the second repairing wire 23. The driving chip 25 is positioned on the FPC 21. In this embodiment, the driving chip 25, the FPC 27 and the source driver 19 are positioned at the same side of the display panel 10. The plurality of the second connection lines 29 and the gate driver 15 are positioned at the same side of the liquid crystal display panel 10, and the first connection lines 17 are parallel to the second connection lines 29.

Referring to FIGS. 1˜2, the gate driver 15 includes a plurality of shift register 151 arranged in cascade connection. Each of the shift registers 151 includes at least one clock pin CLK, a first input pin Stv, a second input pin Va and an output pin Out. The clock pin CLK is configured to receive a clock signal provide by an external device (not showed in the FIGS). The first input pin Stv is configured to receive a starting signal. The second input pin Va is configured to receive a driving control signal, the driving control signal Va is a pulse signal. Each of the shift registers 151 is configured to generate the driving control signal according to the starting signal, and generate the gate signal according to the driving control signal and the clock signal. The output pin is configured to output the gate signal, and is electrically connected to one of the first connection line 17. The shift register 151 successively output a total n gate signals G1, G2, G3, . . . , Gn to the scan lines 11, where n>1.

The plurality of shift registers 151 defines a total n stages shift registers R₁˜Rₙ. The output pin Out of the i^{th} stage shift register Rᵢ is electrically connected to the first input pin Stv of the (i+1)^{th} shift register Rᵢ₊₁, where 1<i<n. Therefore, the gate signal provided by the i^{th} stage shift register Rᵢ is input into the first input pin Stv of the (i+1)^{th} stage shift register Rᵢ₊₁, and is used as the starting signal of the (i+1)^{th} stage shift register Rᵢ₊₁. For example, the output pin Out of the first stage shift register R₁ is electrically connected to the first input pin Stv of the second stage shift register R₂, and the gate signal provide by the first stage shift register R₁ is input into the first input pin Stv of the second stage shift register R₂. Therefore, the gate signal provide by the first stage shift register R₁is used as the starting signal Stv of the second stage shift register R₂.

The driving chip 25 is configured to provide a repairing gate signal and a repairing driving control signal. The first repairing wire 21 is configured to transmit the repairing gate signal; the second repairing wire 23 is configured to transmit the repairing driving control signal. Each of the second connection lines 29 is electrically connected to the second input pin Va of each of the shift register 151. When the gate signal is abnormal, such as the voltage value of the gate signal is off-rating, the driving chip 25 provides the repairing gate signal to the scan line 11 and the first connection lines 17 via the first repairing wire 21. When the driving control signal is abnormal, such as the voltage value of the driving control signal is off-rating, the driving chip 25 provides the repairing driving control signal to the second connection lines 29 via the second repairing wire 23.

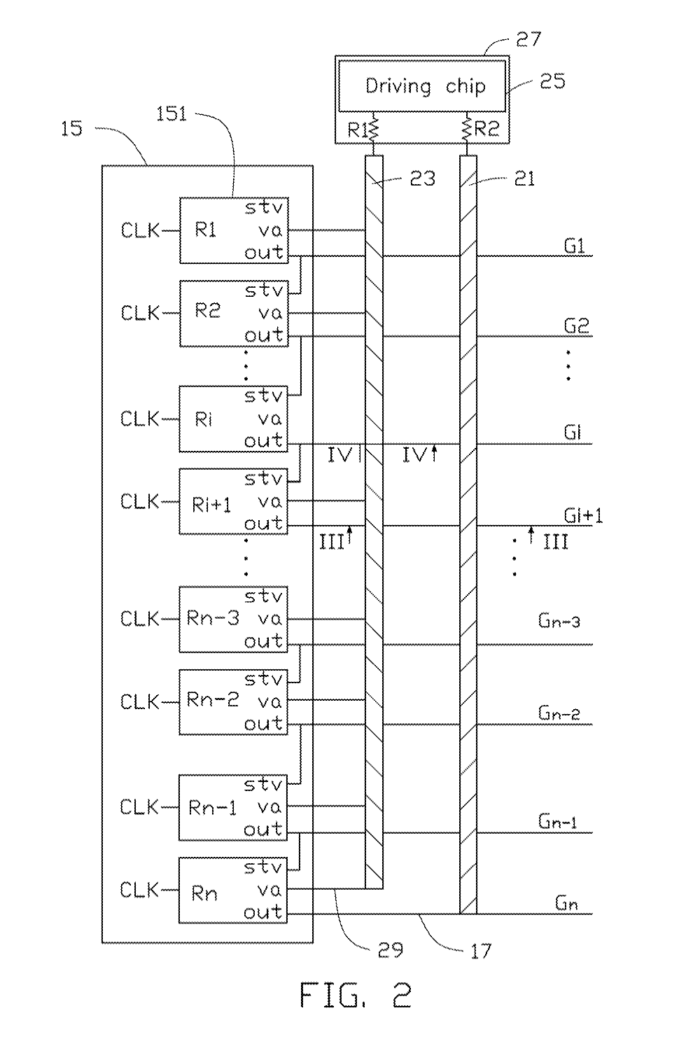

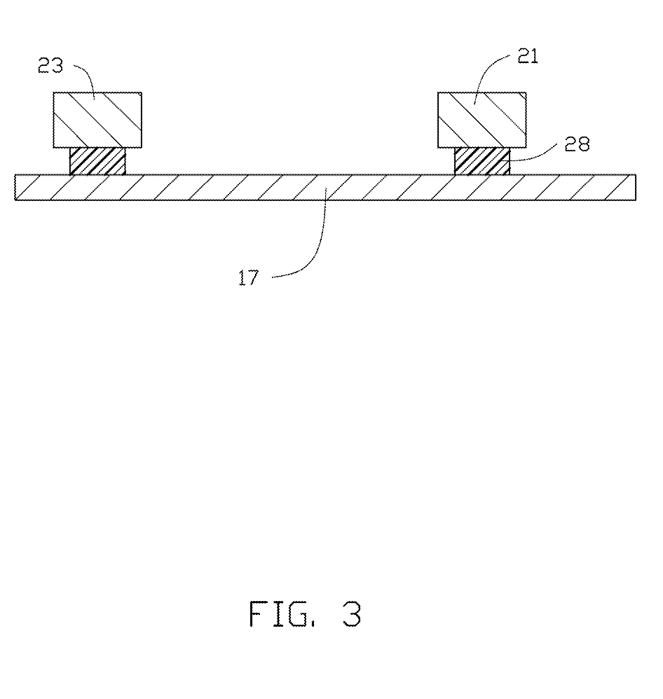

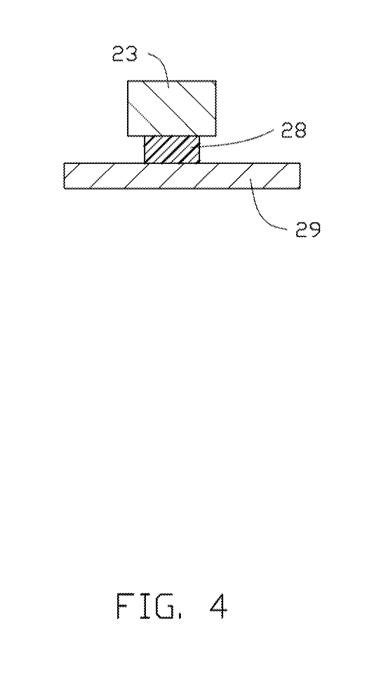

Referring to FIGS. 3-4, FIG. 3 is a cross-sectional view of the repairing structure taken along line of FIG. 2, FIG. 4 is a cross-sectional view of the repairing structure taken along line of FIG. 2. The first repairing wire 21 and the second repairing wire 23 are positioned on the same layer, and are positioned above the first connection lines 17 and the second connection lines 29. An insulated layer 28 is positioned between the first repairing wire 21, the second repairing wire 23 and the first connection lines 17. The insolated layer 28 is also positioned between the second repairing wire 23 and the second connection lines 29. The material of the insolated layer 28 is silicon nitride (Si₃N₄) or silicon dioxide (SiO₂).

If the i^{th} stage shift register Rᵢ is damage, the gate signal provided by the shift register Rᵢ is abnormal, the first repairing wire 21 is set to electrically connect to the first connection line 17 connected to the shift register Rᵢ by a laser device. A first resistance R1 is weld between the driving chip 25 and the first repairing wire 21. The driving chip 25 is configured to provide the repairing gate signal to the first connection line 17 and the first output pin Stv of the (i+1)^{th} stage shift register Rᵢ₊₁. Therefore, the repairing gate signal is used as the gate signal Gi and the starting signal of the stage shift register Rᵢ₊₁.

when the driving control signal input into the second input pin Va of the i^{th} stage shift register Rᵢ is abnormal, the second repairing wire 23 is set to electrically connect to the second connection line 29 by a laser device, a second resistance R2 is weld between the driving chip 25 and the second repairing wire 23. The driving chip 25 is configured to provide the repairing driving control signal to the connection line 29 via the second repairing wire 23. Therefore, the repairing driving control signal is used as the driving control signal of the i^{th} stage shift register Rᵢ.

The first repairing wire 21 is configured to transmit the repairing gate signal to the shift register 151 when the gate signal is abnormal. The second repairing wire 23 is configured to transmit the repairing driving control signal to the shift register 151 when the driving control signal is abnormal. Therefore, the repairing structure 20 can prevent the display panel 10 from been influenced by the damage of the shift register 151 of the gate driver 15.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in the matters of shape, size and arrangement of parts within the principles of the present disclosure to the full extent indicated by the broad general meaning of the terms in which the appended claims are expressed.

What is claimed is:

1. A display panel comprising:
a display region;
a periphery circuit region surrounding the display region;
at least one scan line positioned on the display region;
at least one first connection line positioned on the periphery circuit region;
a gate driver positioned on a periphery circuit region and configured to output a gate signal to the scan line via the connection line;
a repairing structure comprising:
a first repairing wire positioned on the periphery circuit region; and
a driving chip positioned on the periphery circuit region and located at one end of the first repairing wire, the driving chip is configured to output a repairing gate signal to the connection line via the first repairing wire when the gate signal provide to the scan line from the gate driver is abnormal.

2. The display panel of claim 1, wherein the repairing structure comprising:
a second repairing wire positioned on the periphery circuit region;
at least one second connection line positioned on the periphery circuit region and electrically connected to the gate driver;
the gate driver is configured to generate a driving control signal, the driving control signal is configured to control the gate driver output the gate signal;
the second repairing wire is parallel to the first repairing wire, the driving chip is positioned at one end of the second repairing wire, the driving chip is configured to provide a repairing driving control signal to the second connection line and the gate drive via the second repairing wire when the driving control signal of the gate driver is abnormal.

3. The display panel of claim 2, wherein the gate driver includes n stages shift registers R₁˜Rₙ arranged in cascade connection, and each of the shift registers is electrically connected to one of the scan lines via the first connection line, the shift register is configured to output the gate signal to the scan line.

4. The display panel of claim 3, wherein each of the shift register includes a first input pin and, a clock input pin and an output pin, the first input pin is configured to receive a starting signal, the clock input pin is configured to receive a clock signal, the shift register generate the gate signal according to the starting signal and the clock signal, the output pin is configured to output the gate signal to the first connection line and the scan line.

5. The display panel of claim 4, wherein a i^{th} stage of the shift register Rᵢ is cascade connected to the (i+1)^{th} stage of the shift register Rᵢ₊₁, where 1<i<n, the output pin of the i^{th} stage of the shift registers Rᵢ is electrically connected to the first input pin of the (i+1)^{th} stage of the shift register Rᵢ₊₁, the gate signal provided by the i^{th} stage of the shift register Rᵢ is used as the starting signal and is input into the first input pin of the (i+1)^{th} stage of the shift register Rᵢ₊₁, the driving chip is configured to provide the repairing gate signal to the first input pin of the (i+1)^{th} stage shift register Rᵢ₊₁ and the first connection line via the first repairing wire when the gate signal provided by the output pin of the i^{th} stage of the shift register Rᵢ is abnormal.

6. The display panel of claim 3, wherein each of the shift registers includes a second input pin configured to receive the driving control signal, the shift register is configured to generate the driving control signal according to the starting signal, and is configured to generate the gate signal according to the clock signal and the driving control signal.

7. The display panel of claim 6, wherein the second input pin of each of the shift registers is electrically connected to the second connection line, the driving chip is configured to provide the repairing driving control signal to the second connection line via the second repairing wire when the driving control signal of i^{th} shift register Rᵢ is abnormal, where 1<i<n.

8. The display panel of claim 2, wherein the material of the first repairing wire and the second repairing wire are metal, and the first repairing wire and the second repairing wire are positioned on the same layer.

9. The display panel of claim 8, wherein an insulated layer is positioned between the first repairing wire and the first connection line, and the insulated layer is positioned between the second repairing wire, the first connection line and the second connection line.

10. The display panel of claim 9, wherein the material of the insulated layer is silicon nitride or silicon dioxide.

11. The display panel of claim 10, wherein the driving chip is located on a flexible printed circuit board (FPC), and the FPC is positioned on the periphery circuit region.

12. The display panel of claim 10, wherein when the gate signal provided by the shift register is abnormal, the first repairing wire is configured to electrically connect to the first connection line by a laser device, a first resistance is configured to weld between the driving chip and the first repairing wire.

13. The display panel of claim 10, wherein when the driving control signal of the shift register is abnormal, the second repairing wire is configured to electrically connected to the second connection line by a laser device, a second resistance is configured to weld between the driving chip and the second repairing wire.

14. The display panel of claim 2, a plurality of data lines intersected to the scan lines are positioned on a display region, the scan lines and data lines define a plurality of pixel units arranged in an array on the display region, a source driver are positioned on a periphery circuit region, the source driver is electrically connected to the date lines and is configured to output a data signal to the pixel units, the first repairing wire and the second repairing wire are parallel to the data line, the PFC and the source driver are positioned at the same side of the display panel.

15. The display panel of claim 14, the display panel is a liquid crystal display panel.

16. A display panel comprising:
a display region;
a periphery circuit region surrounding the display region;
at least one scan line positioned on the display region;
at least one first connection line positioned on the periphery circuit region;
a scanning driver positioned on a periphery circuit region and configured to provide a scanning signal to the scan line via the connection line;
a repairing structure comprising:
a first repairing wire positioned on the periphery circuit region; and
a driving circuit configured to output a repairing scanning signal to the connection line via the first repairing wire when the scanning signal provided to the scan line from the scanning driver is abnormal.

17. A display panel comprising:
a display region;
a periphery circuit region surrounding the display region;
at least one scan line positioned on the display region;
at least one first connection line positioned on the periphery circuit region;
a gate driver positioned on a periphery circuit region and configured to output a gate signal to the scan line via the connection line;
a repairing structure comprising:
a first repairing wire having at least one end and positioned on the periphery circuit region; and
a driving chip positioned on the periphery circuit region and located at the one end of the first repairing wire, the driving chip configured to output a repairing gate signal to the connection line via the first repairing wire when the gate signal output to the scan line from the gate driver is abnormal.
